(19) United States
(12) Patent Application Publication
(10) Pub. No.: US 2026/0161412 A1
(43) Pub. Date: Jun. 11, 2026

(54) MULTITHREADED INFRASTRUCTURE-AS-CODE DEPLOYMENT

(71) Applicant: Red Hat, Inc., Raleigh, NC (US)

(72) Inventors: Paolo Antinori, Milan (IT); Andrea Cosentino, Milan (IT)

(21) Appl. No.: 18/974,044

(22) Filed: Dec. 9, 2024

(51) Int. Cl. G06F 9/38

(52) U.S. Cl. CPC G06F 9/3836

(57) ABSTRACT

A method can include obtaining, by a computing system comprising one or more first computing devices, data indicative of a plurality of tasks to be deployed to a second computing device. The method can include providing, by the computing system to the second computing device, executable instructions. The executable instructions can include executable instructions to cause one or more processor devices of the second computing device to perform, using a first thread, a first task of the plurality of tasks. The executable instructions can include executable instructions to cause the one or more processor devices of the second computing device to perform, using a second thread executing in parallel with the first thread, a second task of the plurality of tasks.

### BACKGROUND

Infrastructure as code is a technique for managing computing resources using machine-readable files. Infrastructure as code can automate various information technology (IT) administration tasks, such as installations, updates, or patches to software; deployment of virtualization resources (e.g., virtual machines, containers, etc.) or other computing resources; allocation of computing infrastructure (e.g., servers, networks, storage, etc.) to tasks or users; configuration of computing resources; or other IT administration tasks. For example, a machine-readable configuration file can define a desired set of tasks (e.g., deployment tasks, etc.) to be performed or a desired state of a computing system or component (e.g., application, etc.), and an automation engine can perform the tasks or implement the desired state based on the configuration file.

### SUMMARY

The present disclosure is generally directed to systems and methods for multi-threaded parallel execution of infrastructure-as-code tasks.

In one implementation, a method is provided. The method includes obtaining, by a computing system comprising one or more first computing devices, data indicative of a plurality of tasks to be deployed to a second computing device. The method further includes providing, by the computing system to the second computing device, executable instructions. The executable instructions include executable instructions to cause one or more processor devices of the second computing device to perform, using a first thread, a first task of the plurality of tasks. The executable instructions include executable instructions to cause one or more processor devices of the second computing device to perform, using a second thread executing in parallel with the first thread, a second task of the plurality of tasks.

In another implementation, a computing system is provided. The computing system comprises one or more first computing devices. The computing devices are to obtain data indicative of a plurality of tasks to be deployed to a second computing device. The computing devices are further to provide, to the second computing device, executable instructions. The executable instructions include executable instructions to cause one or more processor devices of the second computing device to perform, using a first thread, a first task of the plurality of tasks. The executable instructions include executable instructions to cause one or more processor devices of the second computing device to perform, using a second thread executing in parallel with the first thread, a second task of the plurality of tasks.

In another implementation, a non-transitory computer-readable storage medium is provided. The non-transitory computer-readable storage medium includes executable instructions to cause one or more first processor devices of a first computing device to obtain data indicative of a plurality of tasks to be deployed to a second computing device. The instructions further cause the first processor devices to provide, to the second computing device, executable instructions. The executable instructions include executable instructions to cause one or more processor devices of the second computing device to perform, using a first thread, a first task of the plurality of tasks. The executable instructions include executable instructions to cause one or more processor devices of the second computing device to perform, using a second thread executing in parallel with the first thread, a second task of the plurality of tasks.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment in which examples disclosed herein may be practiced;

FIG. 2A is a flowchart diagram of a method for multi-threaded infrastructure-as-code deployment;

FIG. 2B is a flowchart diagram of a method for multi-threaded infrastructure-as-code deployment;

FIG. 3 is a simplified block diagram of the environment illustrated in FIG. 1 according to one implementation; and

FIG. 4 is a block diagram of a computing device suitable for implementing examples according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

Infrastructure as code is an IT administration strategy that beneficially enables the automation of various IT administration tasks by allowing an administrator to define the tasks in computer-readable files, which are then provided to an automation engine for execution. This automation can provide various benefits, such as reduced labor cost of IT administration, reduced error rates in IT administration, increased flexibility of computing resource allocation, increased repeatability and testability of IT administration actions, and other benefits.

However, existing infrastructure-as-code implementations are not necessarily optimized to minimize an amount of computing resources used to perform tasks defined by an infrastructure-as-code configuration file or otherwise maximize the efficiency of computing resources used to perform the tasks. For example, in some instances, a computing device may have multiple processor devices or multiple processor cores, which can allow the computing device to perform multiple tasks at the same time. However, existing infrastructure-as-code implementations sometimes perform tasks defined by an infrastructure-as-code configuration file sequentially (e.g., in the order they are listed in the configuration file), which can leave some processing resources unused while the tasks are being performed. Therefore, it may be beneficial to provide parallel execution of multiple tasks defined in an infrastructure-as-code configuration file.

However, there are some instances in which parallel execution may be undesirable or infeasible. For example, in some instances, a task defined in a configuration file may depend on successful execution of a previous task, and therefore may be difficult or impossible to perform “early.” For example, in some instances, a first task defined in a configuration file may deploy (e.g., install, load, initialize, etc.) a software tool, and a second task defined in the configuration file may use the software tool to perform the second task. As another example, a first task may update the value of a data variable, and a second task may rely on the updated value. Because of such dependencies, an infrastructure-as-code automation engine cannot parallelize every task. Additionally, an infrastructure-as-code automation system cannot be parallelized without devising strategies to account for such dependencies.

The examples set forth below describe various implementations that can enable parallel execution of infrastructure-as-code tasks, while appropriately accounting for dependencies between tasks. For example, an infrastructure-as-code automation engine can analyze an infrastructure-as-code configuration file and identify any dependencies between tasks. The automation engine can then group the tasks into ordered groups of tasks, which can be referred to as dependency chains, wherein each ordered group of tasks can be performed independently from another ordered group of tasks. As a non-limiting illustrative example, if a configuration file defines five tasks labeled A, B, C, D, and E; and if task B depends on task A, and task D depends on task C, but tasks A, C, and E can be performed independently, then the ordered groups of task can include an A→B group, a C→D group, and a group containing only task E. The ordered groups of tasks can then be executed in parallel, thereby performing the tasks in less time than some alternative implementations.

The examples set forth below can provide a variety of technical effects and benefits. For example, in some instances, executing infrastructure-as-code tasks in parallel can be faster (e.g., lower latency, higher throughput, etc.) compared to some alternative implementations that may execute the tasks sequentially. As another example, in some instances, executing infrastructure-as-code tasks more quickly can reduce an amount of “downtime” that a computing device spends performing infrastructure-as-code tasks (e.g., IT maintenance tasks such as installing updates, etc.), thereby increasing an amount of “uptime” that one or more computing devices can spend performing other computing tasks. Increasing an uptime of a computing device can provide other benefits, such as reducing a computational cost (e.g., hardware cost, electricity cost, processor usage, memory usage, etc.) of performing computing tasks of interest. For example, increasing an uptime of one or more computing devices can increase a number of computing tasks of interest that each computing device can perform (e.g., per hour, per day, etc.). Continuing the example, increasing a number of computing tasks that each computing device can perform can reduce a number of computing devices required to perform a given number of tasks, thereby reducing a hardware cost of performing a given number of computing tasks. Additionally, reducing a number of computing devices that must be operated to perform a given number of tasks can reduce a computational cost of performing the tasks, such as by reducing an amount of electricity or other resources required to operate the reduced number of computing devices.

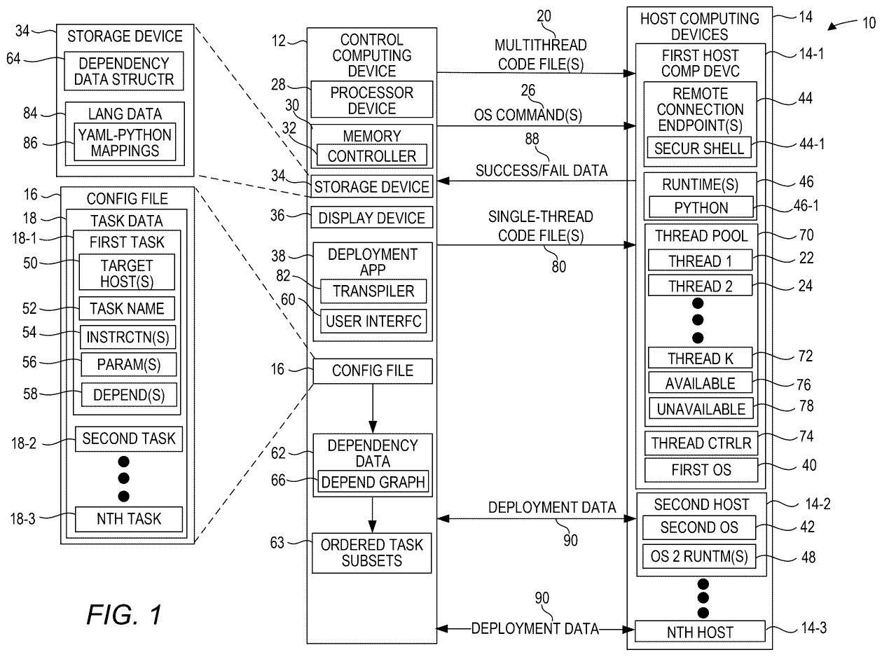

FIG. 1 is a block diagram of an environment in which examples disclosed herein may be practiced. A computing system 10 can include a control computing device 12 and one or more host computing devices 14. The control computing device 12 can retrieve, from a configuration file 16, task data 18 indicative of a plurality of tasks 18-1, 18-2, 18-3 to be deployed to a first host computing device 14-1. The control computing device 12 can generate, based on the task data 18, a multithreaded code file 20. The multithreaded code file 20 can include executable instructions to cause one or more processor devices of the first host computing device 14-1 to perform, using a first thread 22, a first task 18-1 of the plurality of tasks 18-1, 18-2, 18-3. The multithreaded code file 20 can further include executable instructions to cause one or more processor devices of the first host computing device 14-1 to perform, using a second thread 24 executing in parallel with the first thread 22, a second task 18-2 of the plurality of tasks 18-1, 18-2, 18-3. In some instances, the control computing device 12 can further provide, to the first host computing device 14-1, one or more operating system commands 26 to cause the first host computing device 14-1 to execute the executable instructions of the multithread code file 20.

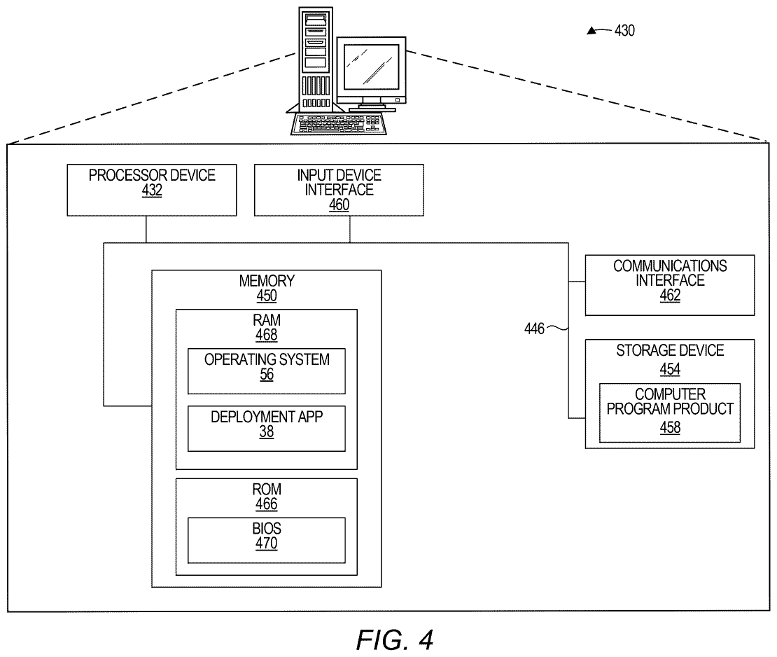

A control computing device 12 may comprise any computing or electronic device capable of including firmware, hardware, and/or executing software instructions to implement the functionality described herein, such as a computer server, a desktop computing device, a laptop computing device, a smartphone, a computing tablet, or the like. Each control computing device 12 of a computing system 10 can include one or more processor devices 28, memories 30 comprising a memory controller 32, storage devices 34, or display devices 36. The control computing device 12 can execute one or more processes (e.g., deployment application 38, etc.). Additional example implementation details for a control computing device 12 are provided below with respect to FIG. 4.

A host computing device 14 may comprise any computing or electronic device capable of including firmware, hardware, and/or executing software instructions to implement the functionality described herein, such as a computer server, a desktop computing device, a laptop computing device, a smartphone, a computing tablet, or the like. In some instances, a host computing device 14 can have any property described herein with respect to a control computing device 12, and vice versa. Additional example implementation details for a host computing device 14 are provided below with respect to FIG. 4.

In some instances, a control computing device 12 may be configured to connect to a plurality of host computing devices 14-1, 14-2, 14-3, such as via a network connection. In some instances, a first host computing device 14-1 can have properties that are the same as or different from one or more other host computing devices 14-2, 14-3, such as a first operating system 40 having an operating system type (e.g., Windows, iOS, Red Hat Enterprise Linux, etc.) or operating system version (e.g., Windows 11, Red Hat Enterprise Linux 7, etc.) that is the same as or different from a type or version of a second operating system 42 of the second host computing device 14-2. Similarly, a host computing device 14-2 can have one or more remote connection endpoints 44 (e.g., secure shell endpoints 44-1, etc.) having a type that is the same as or different from a remote connection endpoint 44 of the second host computing device 14-2; one or more programming language runtimes 46 (e.g., Python runtimes 46-1, Java runtimes, etc.) having a type or version that is the same as or different from a runtime 48 the second host computing device 14-2; or the like. In some instances, a second or Nth host computing device 14-2, 14-3 can have any property described herein with respect to a first host computing device 14-1, and vice versa.

A configuration file 16 can include, for example, any file comprising infrastructure-as-code data, such as a file describing one or more configurations for one or more host computing devices 14, deployment tasks to be performed by one or more host computing devices 14, or other configuration data. In some instances, a configuration file 16 can include structured data in a computing language (e.g., computer-readable structured format, computer-readable language, etc.), such as a markup language (e.g., Extensible Markup Language (XML), etc.), object notation format (e.g., JavaScript Object Notation (JSON), etc.), data serialization language (e.g., YAML Ain't Markup Language (YAML)), programming language (e.g., Python, Java, etc.), or other computing language. For example, in some instances, a configuration file 16 can include one or more YAML files (e.g., YAML files comprising Ansible playbooks, Ansible modules, Ansible roles, etc.) associated with a deployment application 38 configured to process YAML files for infrastructure-as-code deployments, such as the Red Hat Ansible Automation Platform.

In some instances, a configuration file 16 can include task data 18 (e.g., first task 18-1 data, second task 18-2 data, Nth task 18-3 data, etc.) indicative of a plurality of tasks to be performed, such as deployment (e.g., installation, initialization, updating, allocation, etc.) of software resources or other computing resources (e.g., compute nodes such as virtual machines or physical computing devices; storage resources, memory resources, processor resources, or other hardware resources; or the like); configuration of computing resources (e.g., managing settings of a computing devices, states of a computing device, etc.); or other IT administration tasks. In some instances, task data 18 can include data directly or indirectly indicative of a task to be performed, such as imperative data describing a series of steps to be performed; declarative data defining a desired state of one or more computing devices or components, wherein a deployment application 38 can determine one or more actions to perform to reach the desired state; or both.

In some instances, first task 18-1 data can include target host data 50 indicative of one or more host computing devices 14 associated with the tasks, such as one or more host computing devices 14 to perform one or more actions defined imperatively in the configuration file 16; one or more host computing devices 14 to achieve one or more desired states defined declaratively in the configuration file, wherein the actions required to achieve a given state in a first computing device 14-1 may be the same as or different from actions required to achieve the given state in another computing device 14-2, 14-3. In some instances, host data 50 can include data describing one host or a plurality of hosts, such as internet protocol (IP) address data of one or more host computing devices 14; uniform resource locator (URL) data associated with one or more host computing devices 14; or other data identifying one or more target host computing devices associated with a first task 18-1. In some instances, host data 50 can include pattern data (e.g., regular expression data, etc.), wherein every host computing device 14 that matches the pattern data is a target host computing device 14 on which the first task 18-1 should be performed. Example patterns can include a pattern indicative of all host computing devices 14 (e.g., “all” or “*”) of a computing system 10 or host computing device 14 inventory, a pattern indicative of a plurality of IP addresses or URLS (e.g., “*.example.com,” “192.0.*”, etc.), a group name or subgroup name indicative of a plurality of host computing devices 14, a list of individual host computing devices 14 or individual groups, one or more logical operators (e.g., and, not, intersection, union, etc.) for defining groups or subgroups to include in or exclude from a first task 18-1 (e.g., “webservers EXCEPT atlanta”, “webservers UNION dbservers”, “webservers INTERSECT Chicago”, etc.).

In some instances, first task 18-1 data can include identifying data associated with the first task 18-1, such as a task name 52, task identifier (e.g., numerical task identifier, etc.), or other identifying data.

In some instances, first task 18-1 data can include one or more instructions 54 indicative of actions to be performed in the first task 18-1, desired states to be achieved by the first task 18-1, or both. In some instances, instructions 54 can include standalone instructions 54, such as native instructions associated with a machine-readable language (e.g., YAML, etc.), or can include referential instructions 54 (e.g., method calls, etc.) that may refer to additional instructions 54 (e.g., methods, subroutines, Ansible modules, Ansible roles, etc.) that may be stored in a location that is the same as or different from a location of the referential instructions (e.g., in an Ansible module file or Ansible role file that may be different from the configuration file 16, etc.). In some instances, a first task 18-1 can include one instruction 54 (e.g., associated with one action or a one-dimensional desired state, etc.) or a plurality of instructions 54.

In some instances, first task 18-1 data can include one or more parameters 56 for the instructions 54, such as input parameters associated with one or more instructions 54 (e.g., inputs to a method or subroutine, etc.), reference data indicative of parameters to be retrieved (e.g., from a file, database, data structure, memory location, etc.) before performing one or more instructions 54, a variable (e.g., variable data structure configured to store an updatable value, such as integer variable, floating-point variable, object of an object-oriented programming language, struct variable, etc.) whose value is used in one or more instructions 54, a variable whose value is updated by one or more instructions 54, or the like.

In some instances, first task 18-1 data can include express dependency data 58, such as data indicative of one or more dependencies identified by a user in the configuration file 16. For example, in some instances, dependency data 58 can include data indicating that a first task 18-1 must be successfully completed before beginning performance of a second task 18-2; data indicating that one or more first instructions 54 of the first task 18-1 must be successfully performed before beginning performance of one or more second instructions 54 of the first task 18-1; or other data indicative of a dependency (e.g., chronological dependency, data dependency, synchronization requirement, etc.) between two or more instructions 54 or tasks 18-1, 18-2, 18-3 of a configuration file 16. In some instances, dependency data 58 can include data indicative of a required state of a computing system when a task 18-1, 18-2, 18-3 is performed, such as one or more required software, firmware, or hardware components (e.g., packages, libraries, Ansible roles or modules, hardware devices, etc.) that must be deployed (e.g., installed, initialized, allocated, etc.) before a task 18-1, 18-2, 18-3 or instruction 54 can be performed. In some instances, dependency data 58 can include data that can be identified or retrieved based on a keyword (e.g., Ansible “dependencies” keyword, etc.), delimiter, syntax, or other data for tagging dependency data 58.

In some instances, a second task 18-2 or Nth task 18-3 can have any property described herein with respect to a first task 18-1, and second task 18-2 data or Nth task 18-3 data can include data that is the same as, different from, or partially overlaps with corresponding first task 18-1 data. For example, a first task 18-1 can have one or more target hosts 50 that are the same as or different from a target host 50 of a second task 18-2; one or more parameters 56 that are also used as parameters 56 of a second task 18-2; or the like.

In some instances, a configuration file 16 or task data 18 can describe the tasks 18-1, 18-2, 18-3 in an order, such as a top-to-bottom order. For example, in some instances, a configuration file 16 can include a first-listed task 18-1, 18-2, 18-3 starting at a top of the configuration file 16; a second-listed task 18-1, 18-2, 18-3 below the first-listed task 18-1, 18-2, 18-3; and so on, with an Nth-listed task 18-1, 18-2, 18-3 at a bottom of a file. However, a first task 18-1 is not necessarily required to be a first-listed task 18-1, 18-2, 18-3, and neither a first task 18-1 nor a first-listed task 18-1, 18-2, 18-3 are necessarily required to be performed first chronologically by a host computing device 14. For example, the use herein of ordinals in conjunction with an element is solely for distinguishing what might otherwise be similar or identical labels, such as “first task” and “second task,” and does not imply an initial occurrence, a quantity, a priority, a type, an importance, or other attribute, unless otherwise stated herein.

In some instances, the tasks 18-1, 18-2, 18-3 can be described in the configuration file 16 in an order that also corresponds to an optional (e.g., non-mandatory, etc.) but appropriate (e.g., suitable, etc.) chronological order for performing the tasks 18-1, 18-2, 18-3 by the host computing device 14. For example, in some instances, a configuration file 16 can include a file written in a language (e.g., YAML, Python, etc.) wherein a first-listed instruction 54 or first-listed task 18-1, 18-2, 18-3 is presumed to be executed first chronologically by default, or wherein the first-listed instruction 54 or first-listed task 18-1, 18-2, 18-3 is otherwise capable of being executed first chronologically without violating any dependencies or other requirements associated with the configuration file 16. In other words, a configuration file 16 can include task data 18 describing tasks having no dependencies that would require a later-described task 18-1, 18-2, 18-3 to be performed earlier than an earlier-described task 18-1, 18-2, 18-3. However, in some instances, the tasks 18-1, 18-2, 18-3 may have dependencies (e.g., implicit dependencies, dependencies that are not expressly specified in the configuration file 16, etc.) that require an earlier-described task 18-1, 18-2, 18-3 to be performed earlier chronologically compared to a later-described task.

In some instances, a deployment application 38 or other control computing device 12 component can receive a configuration file 16, and can cause one or more host computing devices 14 to perform operations based on the configuration file 16. For example, in some instances, the deployment application 38 can receive (e.g., from a user via a user interface 60 such as a graphical or command-line interface, etc.) a command (e.g., from a user, etc.) requesting a deployment according to the configuration file 16. A command can include, for example, data identifying a filename of the configuration file 16; instruction data to cause the deployment application 38 to perform deployment operations based on the configuration file 16; or the like.

In some instances, a control computing device 12 can, responsive to receiving a deployment command, retrieve task data 18 from the configuration file 16, and perform operations based on the task data 18. For example, the control computing device 12 can determine dependency data 62 based on the task data 18; determine, based on the dependency data 62, a plurality of task subsets 63 that can be performed in parallel, wherein each task subset 63 comprises one or more tasks 18-1, 18-2, 18-3; and generate, based on the plurality of task subsets 63, a multithreaded code file 20 comprising executable instructions to cause a host computing device 14 to perform the task subsets in parallel.

Determining dependency data 62 based on task data 18 can include, for example, retrieving express dependency data 58 from the configuration file 16; identifying one or more implicit dependencies between tasks 18-1, 18-2, 18-3 or instructions 54 based on parameter 56 data, such as implicit dependencies associated with parameters 56 that are shared between a plurality of tasks 18-1, 18-2, 18-3 or instructions 54; retrieving dependency data 62 from a dependency data structure that may be separate from the configuration file 16; or other method for determining dependency data 62.

Identifying implicit dependencies based on parameter 56 data can include, for example, identifying one or more parameters 56 (e.g., variables, files, packages, modules, roles, etc.) that may be shared between two or more tasks 18-1, 18-2, 18-3 or instructions 54 and determining, based on task data 18, whether the shared parameters 56 are associated with a data dependency. For example, in some instances, a data dependency can include a condition in which one task 18-1, 18-2, 18-3 modifies a shared parameter 56, and another task 18-1, 18-2, 18-3 uses a value of the shared parameter 56 for one or more purposes. For example, in some instances, a first task 18-1 may modify a first parameter 56, and a second task 18-2 may use the modified value of the first parameter 56 (i.e., the value of the parameter 56 after the modification by the first task 18-1, etc.) to perform one or more instructions 54. In some instances, this may create a data dependency requiring the first task 18-1 to perform the modification before the second task 18-2 can be performed. As another example, in some instances, a data dependency can include a condition in which a first task 18-1 may use a value of a shared parameter 56 for one or more operations, and a second task 18-2 may modify the value of the shared parameter. In some instances, the task data 18 may specify, implicitly or explicitly, that the first task 18-1 performs the one or more operations using an unmodified value of the shared parameter 56 prior to modification by the second task 18-2. For example, in some instances, task data 18 may implicitly specify that a first task 18-1 should use an unmodified parameter 56 value using a syntax of a machine-readable language (e.g., YAML, etc.), wherein an earlier occurrence of a variable refers to a value of the variable that is unmodified by a later operation modifying the variable. In some instances, a simplified method for determining dependency data 62 based on parameter 56 data can include assuming that a data dependency exists whenever two or more tasks 18-1, 18-2, 18-3 share a parameter 56 (e.g., without analyzing whether any task 18-1, 18-2, 18-3 modifies a value of the parameter 56).

In some instances, a syntax analyzer tool (e.g., parser, compiler comprising a syntax analyzer, etc.) can be used to determine dependency data 62 based on parameter 56 data. For example, in some instances, a syntax analyzer associated with a language of the configuration file 16 (e.g., YAML, etc.) or a language of the multithreaded code file 20 (e.g., Python, etc.) can be used to identify data dependencies between tasks 18-1, 18-2, 18-3 or instructions 54. For example, in some instances, one or more tasks 18-1, 18-2, 18-3 configuration file 16 can be transpiled from a first machine-readable language to a second machine-readable language (e.g., Python, etc.), and a syntax analyzer of the second language can be used to determine dependency data 62. Further details of some example transpiling operations are provided below.

In some instances, dependency data 62 can be retrieved from a dependency data structure 64 storing known dependency data, such as data indicative of dependencies between tasks 18-1, 18-2, 18-3; dependencies between packages, libraries, or the like; dependencies between an instruction 54 and a required state of a host computing device 14 for performing the instruction 54 (e.g., packages or libraries that must be installed, etc.); or other dependency data. For example, in some instances, a dependency data structure 64 can include express dependency data 58 (e.g., user-provided markups indicative of user-identified dependencies, etc.) that is stored outside the configuration file 16. As another example, in some instances, a dependency data structure 64 can include data indicative of one or more dependencies associated with one or more packages or libraries, such as one or more data entries correlating an instruction 54 with a corresponding package or library for performing the instruction. As a non-limiting illustrative example, a dependency data structure 64 can include a database comprising a plurality of data entries, wherein each data entry correlates an instruction 54 (e.g., based on a function name associated with the instruction 54, etc.) with a corresponding package or library for performing the instruction. Other implementations are possible.

In some instances, dependency data 62 can include a dependency graph 66. A dependency graph 66 can include, for example, any graph-structured data indicative of one or more dependency relationships between a plurality of tasks 18-1, 18-2, 18-3, such as a directed acyclic graph of dependencies. Graph-structured data can include, for example, any data format for storing data indicative of one or more graph nodes (e.g., tasks 18-1, 18-2, 18-3) and correlating each graph node with zero or more edges (e.g., dependencies, etc.) connected to the graph node. For example, in some instances, graph-structured data can include a plurality of tuplets (e.g., triplets, etc.) comprising a first node, a second node, and an edge between the nodes. In some instances, a dependency graph 66 can include data indicative of one or more dependency chains, wherein each later task of the dependency chain is dependent on an earlier task of the dependency chain. As a non-limiting illustrative example, if task B is dependent on task A, and task C is dependent on task B, then a dependency chain can include an A→B→C dependency chain.

In some instances, a task 18-1, 18-2, 18-3 can be included in one dependency chain or multiple dependency chains. For example, continuing the non-limiting illustrative example of the previous paragraph, if task D is dependent on task B, then a dependency chain can include an A→B→D dependency chain. In this manner, for instance, tasks C and D can belong to only one dependency chain, whereas tasks A and B can be included in the A→B→C dependency chain and the A→B→D dependency chain. In some instances, such overlapping dependency chains can be represented as separate entities (e.g., with two copies of tasks A and B listed in the separate dependency chains) or as a combined entity, such as a directed acyclic graph comprising a first edge from a task-A node to a task-B node (A→B), a second edge from the task-B node to a task-C node (B→C), and a third edge from the task-B node to the task-D node (B→D).

In some instances, a dependency graph 66 can include a plurality of dependency chains, such as a set of dependency chains sufficient to include all tasks 18-1, 18-2, 18-3 identified in a configuration file 16 in at least one dependency chain. In some instances, the set can include a minimal or near-minimal sufficient set that minimizes or nearly minimizes a number of duplicate tasks in the set. In some instances, the set can include a maximally or near-maximally independent set, wherein all or nearly all dependency chains can be represented as a connected (e.g., weakly connected, etc.) subgraph of the dependency graph 66. As used herein, the term “connected subgraph” can refer to a subgraph wherein each pair of nodes of the subgraph (e.g., tasks 18-1, 18-2, 18-3 of the dependency chain) would be connected by a path of edges of the subgraph (e.g., dependencies between tasks 18-1, 18-2, 18-3 of the dependency chain, etc.), if the edges are treated as undirected.

In some instances, a control computing device 12 can determine a plurality of ordered subsets 63 of the tasks 18-1, 18-2, 18-3 listed in the configuration file 16 based on the dependency data 62. For example, in some instances, each dependency chain of a set (e.g., maximally independent set, etc.) of dependency chains of the dependency graph 66 can correspond to an ordered subset 63, such that each node of the dependency chain is a task 18-1, 18-2, 18-3 of the corresponding ordered subset 63. As another example, in some instances, determining a plurality of ordered subsets 63 of the tasks 18-1, 18-2, 18-3 based on the dependency data 62 can include, for each task 18-1, 18-2, 18-3 of a configuration file 16, performing at least one of: adding the task 18-1, 18-2, 18-3 to an existing ordered subset 63; or generating a new ordered subset 63 consisting of only the task 18-1, 18-2, 18-3. In some instances, the tasks 18-1, 18-2, 18-3 can be processed in an order that corresponds to an order of the configuration file 16. For example, in some instances, an initial ordered subset 63 can include a first-listed task 18-1, 18-2, 18-3 and no other tasks, wherein the first-listed task 18-1, 18-2, 18-3 is located before other tasks in an ordering of the configuration file 16. In some instances, a control computing device 12 can then determine, based on dependency data 62, whether a second-listed task 18-1, 18-2, 18-3 is dependent on the first-listed task 18-1, 18-2, 18-3. If the second-listed task 18-1, 18-2, 18-3 is dependent on the first-listed task 18-1, 18-2, 18-3, then the control computing device 12 can add the second-listed task 18-1, 18-2, 18-3 to the ordered subset 63 comprising the first-listed task 18-1, 18-2, 18-3. In such instances, the dependent task (e.g., second-listed task) 18-1, 18-2, 18-3 can be placed after the task it is dependent on (e.g., first-listed task 18-1, 18-2, 18-3) in an ordering of the ordered subset 63. In contrast, if the second-listed task 18-1, 18-2, 18-3 is not dependent on the first-listed task 18-1, 18-2, 18-3, then the control computing device 12 can generate a new ordered subset 63 comprising only the second-listed task 18-1, 18-2, 18-3. The same process can be performed for each subsequent task. For example, a control computing device 12 can determine, after a second-listed task 18-1, 18-2, 18-3 is added to an ordered subset 63, based on dependency data 62, whether a third-listed task 18-1, 18-2, 18-3 is dependent on the first-listed task 18-1, 18-2, 18-3 or the second-listed task 18-1, 18-2, 18-3. If it is dependent on neither, a new ordered subset 63 comprising only the third-listed task can be generated. If it is dependent on only one of the first-listed task 18-1, 18-2, 18-3 or second-listed task 18-1, 18-2, 18-3, then the third-listed task can be added to an ordered subset 63 associated with the task it is dependent on. If a later task has dependencies associated with two or more earlier-listed tasks 18-1, 18-2, 18-3 (e.g., tasks from different ordered subsets, etc.), then the ordered subsets 63 can in some instances be merged into a single ordered subset 63, and the later task can be added to the merged ordered subset 63. Other implementations are possible.

In some instances, a control computing device 12 can generate, based on one or more of the dependency data 62 or plurality of ordered subsets 63, a multithreaded code file 20.

A multithreaded code file 20 can include, for example, executable instructions to cause a host computing device 14 (e.g., processor device of the host computing device 14, etc.) to perform operations. The operations can include, for example, performing the tasks 18-1, 18-2, 18-3 defined in the configuration file 16 in a multithreaded manner. For example, the operations can include performing, using a first thread 22, a first task 18-1; and performing, using a second thread 24 executing in parallel with the first thread 22, another task 18-2, 18-3. In some instances, the operations can include performing, using a first thread 22, every task 18-1, 18-2, 18-3 of a first ordered subset 63 of a plurality of ordered subsets 63, and performing, using a second thread 24 executing in parallel with the first thread 22, one or more tasks 18-1, 18-2, 18-3 of a second ordered subset 63 of the plurality of ordered subsets 63.

In some instances, a multithreaded code file 20 can include a source code file written in a computer programming language (e.g., Python, Java, etc.); an object code file (e.g., compiled object code file, etc.) generated (e.g., compiled, etc.) based on a source code file; a bytecode file generated based on a source code file; or other file comprising executable instructions.

In some instances, a multithreaded code file 20 can include executable instructions to cause a host computing device 14 to implement a thread pool 70. For example, in some instances, a multithreaded code file 20 can include one or more instructions to initialize a thread pool 70. In some instances, the thread pool 70 can be initialized with a plurality of threads 22, 24, 72. For example, in some instances, a number of threads 22, 24, 72 of the thread pool 70 can be equal to or less than a number of ordered subsets 63 of the plurality of ordered subsets 63 or a number of tasks 18-1, 18-2, 18-3 of the configuration file. In some instances, a number of threads 22, 24, 72 of the thread pool 70 can be selected based at least in part on a hardware configuration of the host computing device 14. For example, in some instances, a control computing device 12 can obtain (e.g., retrieve from a data structure, request and receive from a host computing device 14, etc.) data indicative of a number of processor devices or number of processor cores (e.g., total number of devices, number of available devices, etc.) of the host computing device 14, and can initialize a thread pool 70 having a number of threads 22, 24, 72 based on (e.g., equal to, etc.) a number of processor devices or cores (e.g., available cores, etc.) associated with the host computing device 14.

In some instances, the multithreaded code file 20 can include executable instructions to cause the host computing device 14 to execute one or more ordered subsets 63 using one or more threads 22, 24, 72 of the thread pool 70. For example, in some instances, the multithreaded code file 20 can include executable instructions to cause the host computing device 14 to implement a thread controller 74 that can assign ordered subsets 63 to available threads 76 as they become available. For example, upon initialization of a thread pool 70, all threads 22, 24, 72 can be initially available. In some instances, a thread controller 74 can assign each of K ordered subsets 63 of the plurality of ordered subsets 63 (e.g., K out of N ordered subsets, where N may be greater than K in some instances) to one of K threads 22, 24, 72 of the thread pool 70, wherein K is a number of threads 22, 24, 72 of the thread pool 70. In some instances, the thread controller 74 can track an availability of the threads 22, 24, 72. For example, upon assigning an ordered subset 63 to an available thread 76, an availability status of the thread 76 can be changed to unavailable, such that the thread is an unavailable thread 78. As another example, the thread controller 74 can receive data (e.g., from an unavailable thread 78, etc.) indicating that an ordered subset 63 of tasks 18-1, 18-2, 18-3 have been completed, and the thread controller 74 can determine that the thread 22, 24, 72 that performed the ordered subset 63 is now an available thread 76. Responsive to determining that a thread 22, 24, 72 has become available, the thread controller 74 can assign the available thread 76 to a new ordered subset 63 that has not yet been performed (e.g., performance of which has not yet begun, etc.) by any thread 22, 24, 72. For example, the multithreaded code file 20 can cause the host computing device 14 to maintain a queue or other data structure (e.g., stack, collection, etc.) of ordered subsets 63 that have not yet been executed, and can cause each thread 22, 24, 72 to take an ordered subset 63 from the queue each time the thread 22, 24, 72 becomes available (e.g., upon initialization, upon completion of a prior ordered subset 63, etc.). However, a thread pool 70 is not required. For example, in some instances, the multithreaded code file 20 can include executable instructions to cause the host computing device 14 to implement a number of threads equal to a number of ordered subsets 63 of a plurality of ordered subsets 63, and the threads 22, 24, 72 can be executed without the use of a thread pool 70 or thread controller 74. Other implementations are possible.

In some instances, the multithreaded code file 20 can include executable instructions to cause the host computing device 14 to perform one or more additional operations for managing dependencies (e.g., data dependencies, etc.) between tasks 18-1, 18-2, 18-3 or ordered subsets 63. For example, in some instances, a dependency graph 66 can include one or more branched components, such as one or more nodes associated with tasks 18-1, 18-2, 18-3 on which a plurality of other tasks 18-1, 18-2, 18-3 may depend, or one or more nodes associated with tasks 18-1, 18-2, 18-3 that are dependent on a plurality of other tasks 18-1, 18-2, 18-3. In such instances, it may be desirable to manage dependencies in a manner that does not necessarily include grouping all connected tasks 18-1, 18-2, 18-3 into a single ordered subset 63. As a non-limiting illustrative example, if a plurality of tasks A, B, C, . . . Z, comprise a first dependency chain A→B→C and a second dependency chain A→B→D, one possible implementation can include assigning an A→B→C→D or A→B→D→C ordered subset 63 to a single thread 22, 24, 72, or assigning A→B→C and A→B→D ordered subsets 63 to separate threads 22, 24, 72 if tasks A and B can be harmlessly duplicated. However, an alternate implementation can include creating an A→B ordered subset 63, along with a C-only ordered subset 63 and a D-only ordered subset 63, wherein the C and D ordered subsets 63 can be executed in parallel with each other using different threads 22, 24, 72, but are not permitted to be run until after the A→B ordered subset 63. In such instances, the multithreaded code file 20 can include executable instructions to cause the host computing device 14 to perform one or more synchronization operations (e.g., thread synchronization barriers, thread controller 74 operations, etc.) to prevent the C and D ordered subsets 63 from being performed before the A→B ordered subset 63 is completed. For example, in some instances, a multithreaded code file 20 can include executable instructions to cause the host computing device 14 to implement a data structure (e.g., queue, collection, etc.) from which ordered subsets 63 are retrieved to be assigned to available threads 76, and an initial state of the data structure can include an A→B→addCD ordered subset 63, wherein addCD comprises one or more executable instructions to add a C-only ordered subset 63 and a D-only ordered subset to the data structure. Other implementations are possible.

Although the paragraphs above describe using a single multithreaded code file 20 to cause the host computing device 14 to perform multithreaded operations, other implementations are possible. For example, in some instances, a plurality of single-threaded code files 80 (e.g., with each single-threaded code file 80 comprising an ordered subset 63, etc.) can be provided to the host computing device 14, along with one or more operating system (OS) commands 26 (e.g., executable OS commands, OS commands comprising executable instructions, etc.) to cause the host computing device 14 to execute two or more of the single-threaded code files 80 in parallel (e.g., using two or more threads 22, 24, 72, which can be part of or not part of a thread pool 70, etc.). Other implementations are possible.

In some instances, generating a multi-threaded code file 20 or single-threaded code file 80 can include transpiling (e.g., using a transpiler 82 component of a deployment application 38, etc.) one or more instructions 54 or tasks 18-1, 18-2, 18-3 from a first machine-readable language (e.g., YAML, etc.) associated with the configuration file 16 to a second machine-readable language (e.g., Python, Java, etc.) associated with the code file 20, 80. Transpiling can include, for example, translating one or more units (e.g., lines of computer code, methods, subroutines, instructions 54, tasks 18-1, 18-2, 18-3, etc.) of a configuration file 16 in a first machine-readable language to one or more corresponding units (e.g., lines of computer code such as source code; methods, subroutines, instructions 54, tasks 18-1, 18-2, 18-3, etc.) of a code file 20, 80 in a second machine-readable language. For example, in some instances, a control computing device 12 (e.g., using a transpiler 82, etc.) can transpile one or more instructions 54 or tasks 18-1, 18-2, 18-3 based on language data 84 contained in a language data 84 data structure (e.g., database, file, table, row, column, folder, object, struct, etc.), such as a mapping data structure correlating a plurality of units of the first machine-readable language with a plurality of corresponding units of the second machine-readable language. For example, in some instances, a mapping data structure can include a YAML-Python mapping data structure 86 correlating a plurality of YAML components (e.g., Ansible declarations; scalars, lists, associative arrays, key-value pairs, etc.) to a plurality of corresponding Python components for implementing one or more tasks 18-1, 18-2, 18-3 or instructions 54 described by the YAML components (e.g., Ansible declarations, etc.). For example, in some instances, a control computing device 12 can retrieve, from a configuration file 16, one or more YAML components (e.g., YAML components associated with an instruction 54, task 18-1, 18-2, 18-3, ordered subset 63, or the like); retrieve, from a YAML-Python mapping data structure 86, data indicative of one or more corresponding Python instructions for implementing one or more operations described by the YAML components; and include the Python instructions in the multi-threaded code file 20.

In some instances, a control computing device 12 can provide (e.g., transmit over a communication channel, etc.) the multithreaded code file 20 to one or more host computing devices 14. For example, in some instances, the control computing device 12 can connect to a first host computing device 14-1 via a remote connection endpoint 44 (e.g., remote access protocol endpoint, secure shell protocol endpoint 44-1, etc.) of the first host computing device 14-1. In some instances, the control computing device 12 can provide the multithreaded code file 20 to the first host computing device 14-1 via the secure shell endpoint 44-1. In some instances, the control computing device 12 can further provide (e.g., transmit over a communication channel, such as the internet or other network, etc.) one or more operating system commands 26 to the first host computing device 14-1 via the secure shell endpoint 44-1, such as one or more operating system commands 26 to cause the first host computing device 14-1 to execute the executable instructions of the multithreaded code file 20. For example, in some instances, the first host computing device 14-1 can include one or more runtimes 46 associated with one or more computer programming languages, such as one or more Python runtimes 46-1. In such instances, an operating system command 26 can include a command to cause a runtime 46 to execute the executable instructions of the multithreaded code file 20 (e.g., “python multithreaded_code_file_20.py”, etc.).

In some instances, a multithreaded code file 20 can include operating-system-agnostic executable instructions that can be executed by each of a plurality of respective runtimes 46, 48 respectively associated with a computer programming language of the multithreaded code file 20 (e.g., Python, etc.) on a plurality of respective operating systems 40, 42. For example, in some instances, a first host computing device 14-1 can include a first Python runtime 46-1 for executing Python instructions on a first operating system 40 (e.g., Windows 11, etc.), and a second host computing device 14-2 can include a second Python runtime 46-2 for executing Python instructions on a second operating system 42 (e.g., Red Hat Enterprise Linux 7, etc.) that may be different from the first operating system 40. In some instances, a control computing device 12 can generate a single multithreaded code file 20 and provide the same multithreaded code file 20 to each of the first host computing device 14-1 and second host computing device 14-2. In some instances, the control computing device 12 can provide operating system commands 26 (e.g., same or different operating system commands 26 respectively associated with the different operating systems 40, 42 of the host computing devices 14) to cause the first and second host computing devices 14-1, 14-2 to execute the executable instructions of the multithreaded code file 20 using the respective runtimes 46, 48 associated with their respective operating systems 40, 42.

In some instances, a runtime 46 can execute the tasks 18-1, 18-2, 18-3 using a plurality of threads 22, 24, 72 executing in parallel. A thread 22, 24, 72 can include, for example, an executing process or subprocess that is capable of being independently scheduled for execution by one or more processor devices. For example, a first thread 22 can include a thread of execution that is capable of being executed concurrently (e.g., simultaneously, during overlapping time segments, in parallel, etc.) with one or more other threads 24, 72. For example, in some instances, a first host computing device 14-1 can include a plurality of processor devices, or one or more processor devices having a plurality of processor cores, wherein each core or each processor device can independently execute one or more threads 22, 24, 72 that may be different from one or more threads 22, 24, 72 being concurrently executed by another processor device or processor core. In some instances, a thread 22, 24, 72 can include an executing subprocess that is a component of an executing process such as a runtime 46, application, or other executing process (e.g., an executing process that is referred to by a first operating system 40 as a “process,” etc.). In some instances, the thread 22, 24, 72 can be associated with an executing process (e.g., executing instance of a runtime 46 or application; executing process referred to by a first operating system 40 as a “process”; etc.) that has only one thread (i.e., the first thread 22) or multiple threads. In some instances, a thread 22, 24, 72 can include a kernel thread that may be managed by a first operating system 40 kernel; a user thread that may be implemented by one or more user space components (e.g., libraries, thread controllers 74, etc.); or a hybrid thread type, such as a P:Q thread type that maps P threads 22, 24, 72 to Q kernel entities, where P and Q are integers greater than one (e.g., in contrast to 1:1 kernel threading or P:1 user threading). Similarly, in some instances, a thread controller 74 can include a thread controller 74 implemented by a first operating system 40 (e.g., kernel scheduler, etc.); a thread controller 74 implemented by one or more user-space components (libraries, executing processes in user space, runtimes 46, 48, etc.); or some combination thereof. In some instances, a thread 22, 24, 72 can include a thread that is implemented using preemptive scheduling or cooperative scheduling.

In some instances, the second thread 24 or Kth thread 72 can be associated with (e.g., be executing subprocesses of, components, etc.) one or more executing processes (e.g., instances of an executing application, instances of a programming language runtime 46, units of execution referred to by an operating system as a “process,” etc.) that are the same as or different from an executing process associated with the first thread 22. For example, in some instances, a plurality of single-threaded code files 80 can be provided to the host computing device 14, which may execute them in parallel as a plurality of processes (e.g., plurality of executing instances of a runtime 46, plurality of units of execution referred to by an operating system 40 as a “process,” etc.) wherein each operating system process comprises one or more threads 22, 24, 72.

In some instances, the first host computing device 14-1 can execute the executable instructions of the multithreaded code file 20, and can send success/failure data 88 to the control computing device 12 based on the execution. For example, in some instances, failure data can include exception data or other error data indicating that one or more executable instructions of the multithreaded code file 20 failed to execute. As another example, in some instances, a multithreaded code file 20 may include test data, such as data indicative of one or more desired properties (e.g., settings, configurations, states, etc.) that the first host computing device 14-1 should have after successful deployment of the configuration file 16, and the first host computing device 14-1 can generate success/failure data based on the test data. For example, the first host computing device 14-1 can perform one or more tests based on the test data (e.g., by comparing one or more actual properties of the first host computing device 14-1 to one or more desired properties of the first host computing device 14-1, etc.), and can generate success/failure data based on the tests.

In some instances, the control computing device 12 can perform one or more recovery actions responsive to receiving failure data 88 from the first host computing device 14-1. For example, in some instances, the control computing device 12 can generate a single-threaded code file 80 configured to perform all tasks 18-1, 18-2, 18-3 identified in the configuration file 16 in a chronological order that is based on (e.g., identical to, etc.) a listing order of the configuration file 16, thereby reducing a risk of deployment failures due to undetected dependencies between tasks 18-1, 18-2, 18-3 that may prevent the tasks 18-1, 18-2, 18-3 from being successfully performed out of order. In some instances, the control computing device 12 can take one or more additional recovery actions, such as resetting (e.g., restarting, rolling back, etc.) a state of the first host computing device 14-1 to a state it was in before execution of the multithreaded code file 20; updating a dependency data structure 64, configuration file 16 (e.g., express dependency data 58 of the configuration file 16, etc.), multithreaded code file 20, or other data structure to reflect one or more dependencies identified based on failure data 88; or other corrective action.

In addition to the first host computing device 14-1, the control computing device 12 can interact with additional host computing devices 14-2, 14-3 in any manner described above with respect to a first host computing device 14-1. For example, the control computing device 12 can send and receive deployment data 90 (e.g., code files 20, 80; OS commands 26; success/failure data 88; etc.), which can be the same as or different from corresponding data sent to or received from the first host computing device 14-1, to one or more additional host computing devices 14-2, 14-3. For example, in some instances, a configuration file 16 can include first target host 50 data indicating that a first task 18-1 should be performed by all host computing devices 14-1, 14-2, 14-3 of a computing system 10; and second target host 50 data indicating that a second task 18-2 should be performed by only a subset of the host computing devices 14-1, 14-2, 14-3. In such instances, a code file 20, 80 sent to a second host computing device 14-2 can include executable instructions corresponding to one or more tasks 18-1, 18-2, 18-3 or ordered subsets 63 that are the same as or different from tasks 18-1, 18-2, 18-3 or ordered subsets 63 associated with a multithreaded code file 20 sent to the first host computing device 14-1.

Because the deployment application 38 is a component of the control computing device 12, functionality implemented by the deployment application 38 or components thereof may be attributed to the control computing device 12 generally. Moreover, in examples where the deployment application 38 comprises software instructions that program the processor device 28 to carry out functionality discussed herein, functionality implemented by the deployment application 38 may be attributed herein to the processor device 28. It is further noted that while the transpiler 82 and the user interface 60 of the deployment application 38 are shown as separate components, in other implementations, the transpiler 82 and the user interface 60 could be implemented in a single component or could be implemented in a greater number of components than two.

Similarly, because the remote connection endpoint 44, runtime 46, thread pool 70, first OS 40, and thread controller 74 are components of the first host computing device 14-1, functionality implemented by the remote connection endpoint 44, runtime 46, thread pool 70, first OS 40, and thread controller 74 may be attributed to the first host computing device 14-1 generally. Moreover, in examples where the remote connection endpoint 44, runtime 46, thread pool 70, first OS 40, or thread controller 74 comprises software instructions that program a processor device of the first host computing device 14-1 to carry out functionality discussed herein, functionality implemented by the remote connection endpoint 44, runtime 46, thread pool 70, first OS 40, or thread controller 74 may be attributed herein to the processor device. It is further noted that while the remote connection endpoint 44, runtime 46, thread pool 70, first OS 40, and thread controller 74 are shown as separate components, in other implementations, the remote connection endpoint 44, runtime 46, thread pool 70, first OS 40, and thread controller 74 could be implemented in a single component or could be implemented in a number of components greater than or less than five.

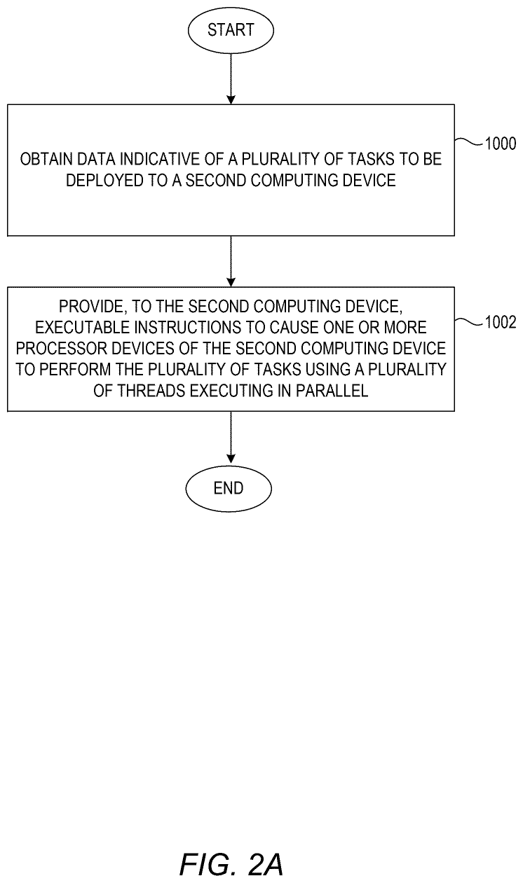

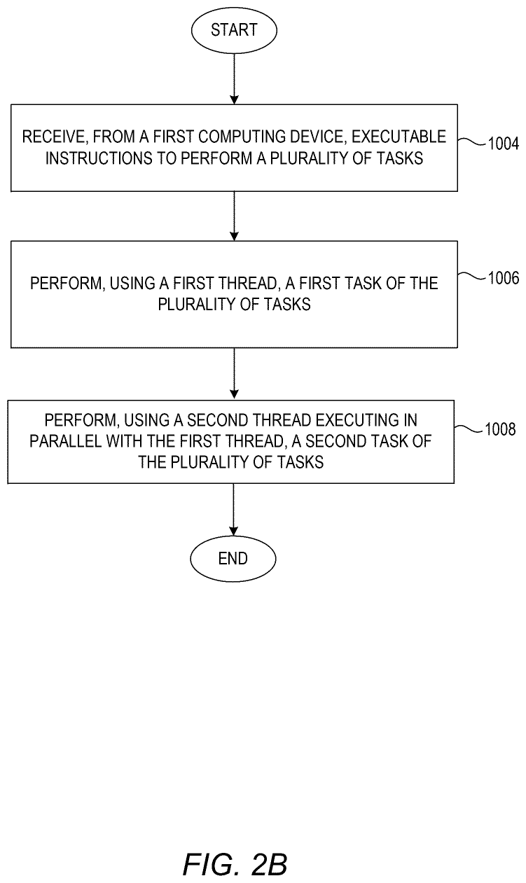

FIG. 2A is a flowchart diagram of a method for multi-threaded infrastructure-as-code deployment. Although FIG. 2A depicts steps in a particular order for purposes of illustration and discussion, the present disclosure is not limited to the particularly illustrated order or arrangement. For example, various steps can be omitted, added, rearranged, or otherwise modified without deviating from the scope of the present disclosure.

At 1000, the method of FIG. 2A can include obtaining (e.g., by a control computing device 12, from a configuration file 16, etc.) data indicative of a plurality of tasks (e.g., first task 18-1 data, second task second task 18-2 data, Nth task 18-3 data, etc.) to be deployed to a second computing device (e.g., first host computing device 14-1, second host computing device 14-2, Nth host computing device 14-3, etc.). In some instances, the method of FIG. 2A can include, at 1000, performing one or more operations or using one or more components described above with respect to FIG. 1.

At 1002, the method of FIG. 2A can include providing, to the second computing device, executable instructions (e.g., in a multithread code file 20, etc.) to cause one or more processor devices of the second computing device to perform the plurality of tasks using a plurality of threads (e.g., first thread 22, second thread 24, Nth thread 72, etc.) executing in parallel. For example, in some instances, the executable instructions can include instructions to cause the one or more processor devices to perform one or more actions described below with respect to FIG. 2B. In some instances, the method of FIG. 2A can include, at 1002, performing one or more operations or using one or more components described above with respect to FIG. 1.

FIG. 2B is a flowchart diagram of a method for multi-threaded infrastructure-as-code deployment. Although FIG. 2B depicts steps in a particular order for purposes of illustration and discussion, the present disclosure is not limited to the particularly illustrated order or arrangement. For example, various steps can be omitted, added, rearranged, or otherwise modified without deviating from the scope of the present disclosure.

At 1004, the method of FIG. 2B can include receiving (e.g., by a host computing device 14, etc.), from a first computing device (e.g., control computing device 12, etc.), executable instructions (e.g., multithread code files 20, etc.) to perform a plurality of tasks. In some instances, the method of FIG. 2B can include, at 1004, performing one or more operations or using one or more components described above with respect to FIG. 1.

At 1006, the method of FIG. 2B can include performing, using a first thread (e.g., first thread 22, etc.), a first task (e.g., first task 18-1, etc.) of the plurality of tasks. In some instances, the method of FIG. 2B can include, at 1004, performing one or more operations or using one or more components described above with respect to FIG. 1.

At 1008, the method of FIG. 2B can include performing, using a second thread (e.g., second thread 24, etc.) executing in parallel with the first thread, a second task (e.g., second task 18-2, etc.) of the plurality of tasks. In some instances, the method of FIG. 2B can include, at 1004, performing one or more operations or using one or more components described above with respect to FIG. 1.

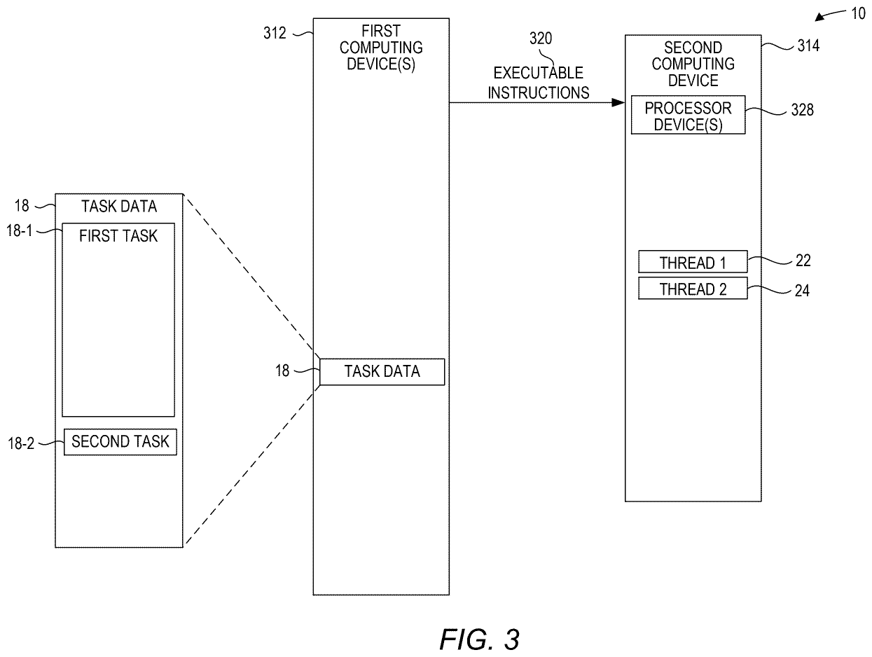

FIG. 3 is a simplified block diagram of the environment illustrated in FIG. 1 according to one implementation. A first computing device 312 can obtain task data 18 indicative of a plurality of tasks 18-1, 18-2. Based on the task data 18, the first computing device 312 can provide executable instructions 320 to a second computing device 314. The executable instructions 320 can include executable instructions to cause one or more processor devices 328 of the second computing device 314 to perform, using a first thread 22, a first task 18-1 of the plurality of tasks 18-2. The executable instructions 320 can further include executable instructions to cause the one or more processor devices 328 to perform, using a second thread 24 executing in parallel with the first thread 22, a second task 18-2 of the plurality of tasks 18-1, 18-2.

In some instances, a first computing device 312 can be, comprise, be comprised by, or otherwise share one or more properties with a control computing device 12. For example, in some instances, a first computing device 312 can have any property described herein with respect to a control computing device 12.

In some instances, a second computing device 314 can be, comprise, be comprised by, or otherwise share one or more properties with a host computing device 14. For example, in some instances, a first computing device 314 can have any property described herein with respect to a host computing device 14.

In some instances, executable instructions 320 can be, comprise, be comprised by, or otherwise share one or more properties with one or more code files 20, 80. For example, in some instances, a first computing device 314 can have any property described herein with respect to a code file 20, 80 or executable instructions therein.

In some instances, a processor device 328 can have any property described herein with respect to a processor device 28 or with respect to one or more processor devices described below with respect to FIG. 4.

FIG. 4 is a block diagram of a computing device 430 suitable for implementing examples according to one example. The computing device 430 may comprise any computing or electronic device capable of including firmware, hardware, and/or executing software instructions to implement the functionality described herein, such as a computer server, a desktop computing device, a laptop computing device, a smartphone, a computing tablet, or the like. The computing device 430 includes the processor device 432, the system memory 450, and a system bus 446. The system bus 446 provides an interface for system components including, but not limited to, the system memory 450 and the processor device 432. The processor device 432 can be any commercially available or proprietary processor.

The system bus 446 may be any of several types of bus structures that may further interconnect to a memory bus (with or without a memory controller), a peripheral bus, and/or a local bus using any of a variety of commercially available bus architectures. The system memory 450 may include non-volatile memory 466 (e.g., read-only memory (ROM), erasable programmable read-only memory (EPROM), electrically erasable programmable read-only memory (EEPROM), etc.), and volatile memory 468 (e.g., random-access memory (RAM)). A basic input/output system (BIOS) 470 may be stored in the non-volatile memory 466 and can include the basic routines that help to transfer information between elements within the computing device 430. The volatile memory 468 may also include a high-speed RAM, such as static RAM, for caching data.

The computing device 430 may further include or be coupled to a non-transitory computer-readable storage medium such as the storage device 454, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 454 and other drives associated with computer-readable media and computer-usable media may provide non-volatile storage of data, data structures, computer-executable instructions, and the like.

A number of modules can be stored in the storage device 454 and in the volatile memory 468, including an operating system and one or more program modules, such as the deployment application 38, which may implement the functionality described herein in whole or in part. All or a portion of the examples may be implemented as a computer program product 458 stored on a transitory or non-transitory computer-usable or computer-readable storage medium, such as the storage device 454, which includes complex programming instructions, such as complex computer-readable program code, to cause the processor device 432 to carry out the steps described herein. Thus, the computer-readable program code can comprise software instructions for implementing the functionality of the examples described herein when executed on the processor device 432. The processor device 432, in conjunction with the deployment application 38 in the volatile memory 468, may serve as a controller, or control system, for the computing device 430 that is to implement the functionality described herein.

An operator, such as a user, may also be able to enter one or more configuration commands through a keyboard (not illustrated), a pointing device such as a mouse (not illustrated), or a touch-sensitive surface such as a display device. Such input devices may be connected to the processor device 432 through an input device interface 460 that is coupled to the system bus 446 but can be connected by other interfaces such as a parallel port, an Institute of Electrical and Electronic Engineers (IEEE) 1394 serial port, a Universal Serial Bus (USB) port, an IR interface, and the like. The computing device 430 may also include the communications interface 462, such as an Ethernet transceiver and/or a Wi-Fi transceiver, or the like, suitable for communicating with a network as appropriate or desired. The computing device 430 may also include a video port configured to interface with a display device, to provide information to a user.

Individuals will recognize improvements and modifications to the preferred examples of the disclosure. All such improvements and modifications are considered within the scope of the concepts disclosed herein and the claims that follow.

What is claimed is:

1. A method comprising:
obtaining, by a computing system comprising one or more first computing devices, data indicative of a plurality of tasks to be deployed to a second computing device; and
providing, by the computing system to the second computing device, executable instructions to cause one or more processor devices of the second computing device to:
perform, using a first thread, a first task of the plurality of tasks; and
perform, using a second thread executing in parallel with the first thread, a second task of the plurality of tasks.

2. The method of claim 1, wherein obtaining the data indicative of the plurality of tasks comprises retrieving the data from a configuration file, and further comprising:
mapping, by the computing system based on the configuration file, the plurality of tasks to a plurality of ordered subsets of the plurality of tasks, wherein each ordered subset of the plurality of ordered subsets can be performed independently of each other ordered subset of the plurality of ordered subsets; and
wherein the first thread is a thread for executing a first ordered subset of the plurality of ordered subsets, and the second thread is a thread for executing a second ordered subset of the plurality of ordered subsets.

3. The method of claim 2, wherein mapping the plurality of tasks to the plurality of ordered subsets comprises:
for each respective task of the plurality of tasks:
identifying, by the computing system based on the configuration file, a respective set of zero or more dependencies comprising zero or more other tasks of the plurality of tasks that must be performed before the respective task can be performed; and
assigning, by the computing system based on the respective set of zero or more dependencies, the respective task to a corresponding ordered subset comprising at least the respective task and the zero or more other tasks, wherein an order of the corresponding ordered subset includes performing the zero or more other tasks before performing the respective task.

4. The method of claim 3, wherein identifying the respective set of zero or more dependencies comprises:
generating, by the computing system based on the configuration file, data indicative of a directed acyclic graph of dependencies associated with the configuration file.

5. The method of claim 3, wherein identifying the respective set of zero or more dependencies comprises retrieving, by the computing system from the configuration file, dependency data expressly defining one or more dependencies of the respective set of zero or more dependencies.

6. The method of claim 3, wherein identifying the respective set of zero or more dependencies comprises:
retrieving, by the computing system from the configuration file, data indicative of one or more parameters associated with the respective task of the plurality of tasks;
retrieving, by the computing system from the configuration file, data indicative of zero or more earlier tasks that alter a value of at least one parameter of the one or more parameters, wherein each earlier task of the zero or more earlier tasks appears at an earlier point in the configuration file compared to the respective task; and
adding, by the computing system to the respective set of zero or more dependencies, the zero or more earlier tasks.

7. The method of claim 1, wherein the executable instructions are further to cause the one or more processor devices to:
generate a thread pool comprising at least the first thread and the second thread;
allocate, from the thread pool, the first thread to the first task; and
allocate, from the thread pool, the second thread to the second task.

8. The method of claim 1, further comprising:
connecting, by the computing system using a remote access protocol, to the second computing device;
transmitting, by the computing system to the second computing device using the remote access protocol, a file comprising the executable instructions; and
transmitting, by the computing system to the second computing device using the remote access protocol, a signal to cause the second computing device to execute the file.

9. The method of claim 8, wherein the remote access protocol is a secure shell protocol.

10. The method of claim 8, wherein the second computing device comprises a runtime associated with a computer programming language, wherein the executable instructions are instructions in the computer programming language, and wherein the signal is a signal to cause the runtime to execute the file.

11. The method of claim 10, wherein the executable instructions are operating-system-agnostic executable instructions that can be executed by a plurality of respective runtimes respectively associated with the computer programming language on a plurality of respective operating systems.

12. The method of claim 1, wherein obtaining the data comprises obtaining the data from a first file comprising one or more declarations in a first computing language, and further comprising transpiling the one or more declarations into a second computing language different from the first computing language to generate a second file comprising the executable instructions.

13. The method of claim 12, wherein transpiling the one or more declarations comprises:
retrieving, by the computing system from the first file, data indicative of a first declaration of the one or more declarations;
mapping, by the computing system, the first declaration to a corresponding first set of instructions in the second computing language; and
adding, by the computing system, the corresponding first set of instructions to the second file.

14. The method of claim 1, further comprising:
receiving, by the computing system from the second computing device, at least one of:
data indicative of a success in executing the executable instructions; and
data indicative of a failure in executing the executable instructions.

15. The method of claim 14, wherein the executable instructions are first executable instructions, wherein obtaining the data comprises retrieving the data from a configuration file, and further comprising:
providing, by the computing system to the second computing device responsive to receiving the data indicative of the failure, second executable instructions to cause the one or more processor devices to:
perform, using a single thread in a first order that is identical to a second order in which the configuration file is arranged, the plurality of tasks.

16. The method of claim 1, wherein obtaining the data indicative of the plurality of tasks comprises retrieving the data from a configuration file comprising the data indicative of the plurality of tasks, and wherein the configuration file further comprises first host data identifying one or more host computing devices to which the first task should be deployed, wherein the one or more host computing devices comprise the second computing device.

17. A computing system comprising one or more first computing devices to:
obtain data indicative of a plurality of tasks to be deployed to a second computing device; and
provide, to the second computing device, executable instructions to cause one or more processor devices of the second computing device to:
perform, using a first thread, a first task of the plurality of tasks; and
perform, using a second thread executing in parallel with the first thread, a second task of the plurality of tasks.

18. The computing system of claim 17, wherein to obtain the data indicative of the plurality of tasks the computing system is to retrieve the data from a configuration file, and wherein the computing system is further to:
map, based on the configuration file, the plurality of tasks to a plurality of ordered subsets of the plurality of tasks, wherein each ordered subset of the plurality of ordered subsets can be performed independently of each other ordered subset of the plurality of ordered subsets; and
wherein the first thread is a thread for executing a first ordered subset of the plurality of ordered subsets, and the second thread is a thread for executing a second ordered subset of the plurality of ordered subsets.

19. The computing system of claim 17, wherein the executable instructions are further to cause the one or more processor devices to:
generate a thread pool comprising at least the first thread and the second thread;
allocate, from the thread pool, the first thread to the first task; and
allocate, from the thread pool, the second thread to the second task.

20. A non-transitory computer-readable storage medium that includes executable instructions to cause one or more first processor devices of a first computing device to:
obtain data indicative of a plurality of tasks to be deployed to a second computing device; and
provide, to a second computing device, executable instructions to cause one or more second processor devices of the second computing device to:
perform, using a first thread, a first task of the plurality of tasks; and
perform, using a second thread executing in parallel with the first thread, a second task of the plurality of tasks.
